(19) United States
(12) Patent Application Publication
(10) Pub. No.: US 2013/0240587 A1
(43) Pub. Date: Sep. 19, 2013

(54) HOLDER FOR MOTOR VEHICLES FOR RECEIVING MOBILE DEVICES

(71) Applicant: Thomas Buchhalter, Niederkassel (DE)

(72) Inventor: Thomas Buchhalter, Niederkassel (DE)

(21) Appl. No.: 13/989,862

(22) PCT Filed: Nov. 24, 2011
(86) PCT No.: PCT/EP11/70916

§ 371 Date: May 28, 2013

(30) Foreign Application Priority Data
Nov. 25, 2010 (DE) 202010015867

(51) Int. Cl. B60R 11/00

(52) U.S. Cl. CPC B60R 11/00
USPC 224/570

(57) ABSTRACT

A holder for motor vehicles for receiving a mobile device, with a housing and with clamping jaws for clamping the mobile device, the housing is equipped with a dedicated power supply for the clamping operation, wherein the clamping jaws are movable electromechanically for opening or closing purposes.

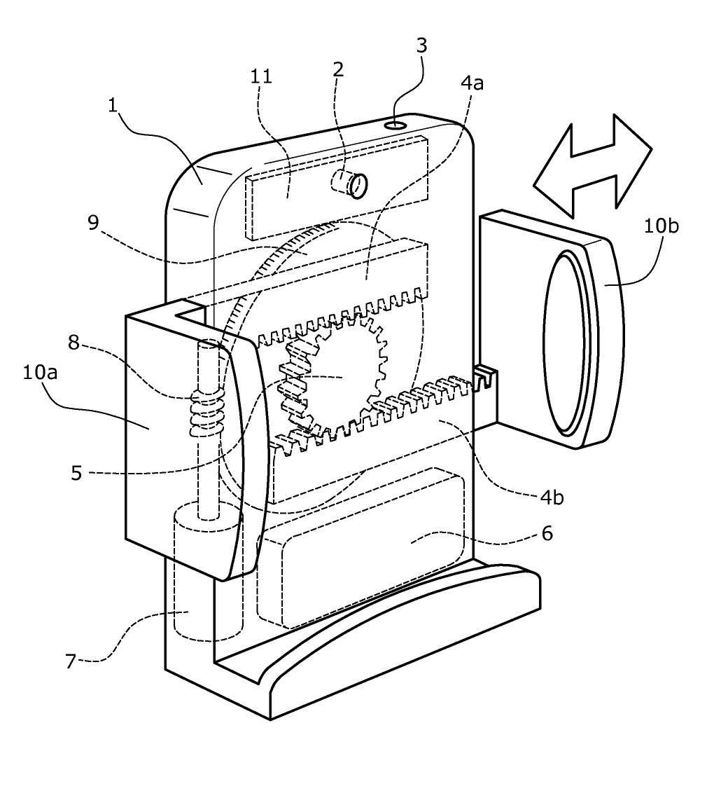

The invention refers to a holder for receiving mobile devices, in particular navigation or communication apparatuses, in vehicles according to the preamble of claim 1.

Such a holder, i.e. a clamping device for mobile apparatuses, is known, for example, from DE 296 18 476. The known holder comprises two clamping jaws supported in a housing, which are adapted to be pressed manually so as to retain a mobile apparatus in a certain locked position of the clamping jaws. The adjustable clamping jaws allow for an adaptation to different apparatuses so that such holders can be offered as universal devices for different mobile apparatuses.

The mobile apparatuses may be navigation or communication apparatuses for instance, such as mobile phones or smart phones.

So far, all holders on the market are operated purely mechanically.

The mobile apparatuses are mechanically clamped or locked in the holder. Others are biased against a spring and are then unlocked again.

In quite a few cases, the operation requires the use of both hands.

This is inconvenient and partly difficult and practicable only with both hands.

Therefore, it is an object of the invention to provide a holder of the type mentioned above which offers maximum ease of use and requires no mechanical force to be exercised by the user.

The object is achieved with the features of claim 1.

The invention advantageously provides that the housing is equipped with a separate energy supply for the clamping operation, with the clamping jaws being adapted to be moved electromechanically for closing and opening. The invention overcomes the disadvantages described above by providing an electromechanical automatic clamping of the mobile apparatus.

For this purpose, it is preferably provided that an electric motor is provided to move at least one of the clamping jaws.

The energy supply may be effected from the on-board supply of the vehicle via a connector cable or from an integrated battery/accumulator unit or it may additionally be provided with solar cells, i.e. such that an integrated battery/accumulator unit can also be assisted by solar cells.

Preferably, the housing is provided with sensors for the opening and closing of the clamping jaws, wherein one sensor arranged at the housing detects the insertion of the mobile apparatus so that the clamping jaws can close, and, if so desired, an opening sensor at the housing opens the clamping jaws upon actuation by an operator.

The following is a detailed description of an embodiment of the invention with reference to the sole Figure.

The sole Figure illustrates a housing 1 of the holder in which two clamping jaws 10a, 10b are supported for movement in the direction of an arrow. At the lower end of the housing 1, a support surface for a mobile apparatus is provided on which the mobile apparatus can be supported from below. When the mobile device is placed on this surface and rests on a rear support surface of the housing 1, a sensor 2 arranged in the housing 1 detects the presence of the mobile apparatus, e.g. through an opening in the housing 1, whereupon an electronic unit 11 arranged in the housing 1 controls a drive motor 7 to drive the clamping jaws 10a, 10b. Preferably, the motor 7 is coupled with the clamping jaws 10a, 10b via a transmission unit, wherein, in the embodiment illustrated, the transmission unit comprises a drive screw 8 driven by the motor 7, the drive screw meshing with a large drive pinion 9 via the toothing. The large pinion 9 is coaxially coupled with a small pinion 5 for rotation therewith. The small pinion 5 meshes with two toothed drive bars 4a, 4b movable in the direction of the arrow and preferably guided linearly, the bars being fixedly connected with a respective clamping jaw 10a and 10b. When the small pinion 5 rotates clockwise, with respect to the drawing, the clamping jaws 10a, 10b perform a closing movement, whereas, upon a rotational movement in the counterclockwise direction, the clamping jaws 10a, 10b are opened. For opening, the motor 7 is rotated in the opposite sense. The control receives a corresponding command via the opening sensor 3 arranged at the housing. The sensors 2,3 may be configured as optical, capacitive or mechanical sensors, e.g. in form of a button or of a touch-sensitive sensor. Current-saving sensors are preferred.

It is understood that other drive and transmission units can also be used to move the clamping jaws.

The electronic unit 11 can store a clamping position for a particular mobile apparatus, wherein, in this case, the opening position of the clamping jaws 10a, 10b is obtained by the clamping jaws 10a, 10b moving part by a short predetermined distance. In this manner, short opening and closing paths are achieved, so that the power consumption during the operation of the holder is low.

A battery or accumulator unit may be integrated in the housing, the accumulator advantageously being adapted to be charged also via a solar cell when light impinges thereon.

Storing the clamping position can be performed in a simple manner by the electronic unit 11 itself by detecting the clamping state, e.g. the rise in the power consumption of the motor 7.

When another, e.g. a wider mobile apparatus is to be held in the holder, it is sufficient, for example, to operate the opening sensor 3 twice or for a longer time in order to move the clamping jaws 10a, 10b to the fully open position. Again, the maximum opening position can be detected by the electronic unit 11 when the drive bars 4a, 4b connected with the clamping jaws 10a, 10b abut against a stop. The clamping position for the new mobile apparatus can then be stored as described above.

It is intended, in particular, to avoid the necessity of an inconvenient two-handed operation.

The holder is designed as a passive holding head that can be applied to various supporting systems of various manufacturers which are known for fastening in the interior of a vehicle, preferably on the dashboard or the windshield, e.g. using a suction cup having a pivot arm.

The holder can also be provided with a charging function for the mobile apparatus.

Advantageously, the electromechanically actuable holder is designed such that it is pivotable and can thus be pivoted from a vertical orientation of the mobile apparatus to a horizontal orientation. Further, it is intended to provide an integrated possibility for charging the mobile apparatus.

Preferably, the power for the clamping operation is provided by a battery/accumulator unit 6 integrated in the holder, which unit may also be supported by a solar cell that further reduces the energy consumption of the battery when it is light or that charges the accumulator unit during the day.

The electromechanical holder is intended for accommodation in a housing which is preferably made of plastic material.

Clamping is effected by two clamping jaws 10a, 10b that are moved electromechanically for opening or closing.

The drive may advantageously be electric.

The motor 7 drives a transmission unit formed by the elements 4a, 4b, 5, 8 and 9 which open and close the clamping jaws 10a, 10b.

The control of the unit 11 is designed such that the mobile apparatus is pressed against a sensor 2 arranged at the housing 1, whereby the clamping operation is started.

The clamping is then advantageously released by means of an opening sensor 3 preferably arranged at the top of the housing, the sensor being touched with a finger.

An adjustment to different widths of mobile terminal apparatuses is done automatically by storing a position in an electronic unit 11 upon the first movement.

The deactivation of and the correct contact pressure for the clamping is detected and stored by the integrated electronic unit 11.

When the opening sensor 3 is actuated, the clamping is released slightly so that the mobile apparatus can be removed easily.

Due to the slight opening, only a small closing distance needs to be traveled when the mobile terminal apparatus reinserted to be used again, which again is favorable in terms of energy consumption.

1. Holder for use in motor vehicles for receiving a mobile device, with a housing and with clamping jaws for clamping the mobile device, wherein the housing is equipped with a dedicated power supply for the clamping operation, the clamping jaws being movable electromechanically for opening or closing purposes.

2. Holder of claim 1, wherein an electric motor is provided for moving at least one of the clamping jaws.

3. Holder of claim 1, wherein the power supply is provided with solar cells.

4. Holder of claim 1, wherein the housing is equipped with sensors for opening or closing the clamping jaws.

5. Holder of claim 4, wherein an electronic unit is integrated that controls the closing and opening function in dependence on sensor signals from the sensors.

6. Holder of claim 5, wherein the electronic unit stores opening and closing positions of the clamping jaws.
